(19) United States
(12) Patent Application Publication
(10) Pub. No.: US 2002/0195043 A1
(43) Pub. Date: Dec. 26, 2002

(54) BOTTLE-TOP WHISTLE

(76) Inventors: Robert R. Stawski JR., Livingston, NJ (US); Mary J. Stawski, Livingston, NJ (US)

Correspondence Address: ROBERT & MARY STAWSKI, 12 LEE ROAD, LIVINGSTON, NJ, 07039, US

(21) Appl. No.: 09/885,738

(22) Filed: Jun. 20, 2001

(51) Int. Cl. G10K 5/00

(52) U.S. Cl. 116/137 R; 446/216

(57) ABSTRACT

A whistle is mounted to the top of a beverage bottle. The whistle can be opened for use and closed when not in use so as to be out of the way. The whistle does not prevent the user from being able to drink the beverage.

### BACKGROUND OF THE INVENTION

The invention relates to novelty devices, and more particularly relates to noisemakers. In its most immediate sense, the invention relates to a novelty whistle that can be sealed over a bottle top. At venues such as arenas and large stadiums, patrons purchase food, beverages, and novelty items. And, at sports events, it is common for fans to express approval by making noise. It would be advantageous to provide a novelty noisemaker that could be conveniently used even if the user is holding e.g. a beverage bottle.

In accordance with the invention, a whistle is provided that can be sealed over the top of a bottle. The whistle has a central tube through which liquid can flow out of the bottle. In preferred embodiments, the whistle is made entirely of plastic and can be threaded onto the top of a conventional soda bottle and the cap of the bottle threaded in turn on the whistle. Alternatively, the whistle can be sealed to the top of a bottle otherwise than by being threaded on it.

It is particularly advantageous if the whistle has a whistle body that can be pivoted outwardly for ease of use and pivoted inwardly when not in use, without interfering with the tube.

### BRIEF DESCRIPTION OF THE DRAWINGS

The invention will be better understood with reference to the following illustrative and non-limiting drawings, in which:

FIG. 1 is an exploded view of a preferred embodiment of the invention;

FIG. 2 schematically illustrates the preferred embodiment in an open position;

FIG. 3 schematically illustrates how the preferred embodiment opens and closes without interfering with a straw;

FIG. 4 is a cross-sectional view of the preferred embodiment of the invention; and

FIG. 5 is a cross-sectional view of an alternate embodiment of the invention.

### DETAILED DESCRIPTION OF PREFERRED EMBODIMENTS

The drawings are not necessarily to scale, and individual parts or portions of the preferred embodiment(s) may be exaggerated for clarity. The same element is always indicated using the same reference numeral.

In accordance with the preferred embodiment of the invention, a whistle generally indicated by reference numeral 2 is mounted to the top 4 of a beverage bottle 6. As will be better understood hereinafter, the whistle 2 can be blown while the user (not shown) holds the bottle 6, and the user can also drink the contents (not shown) of the bottle 6 through a tube 8. And, as will also be better understood hereinafter, the whistle 2 is blown by rotating the whistle body 36 out of a housing formed by two housing halves 12 and 14 so that a user can easily blow into it. When the whistle 2 is not being blown, the whistle body 36 can be rotated back into the housing, where the whistle is out of the way.

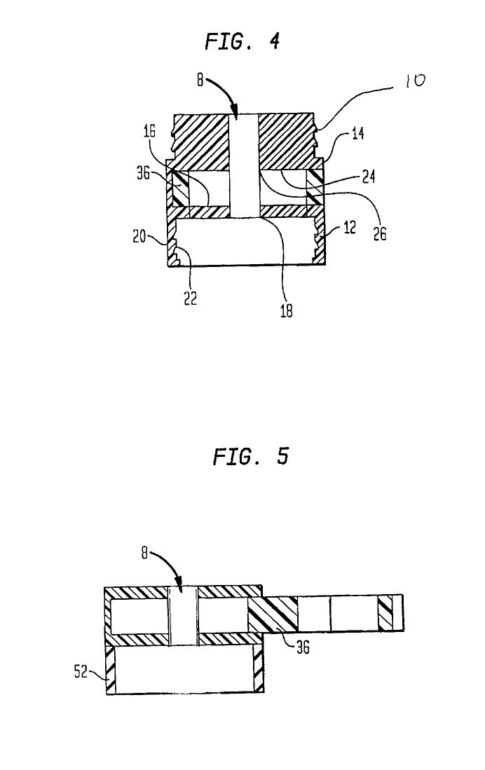

The whistle 2 has a lower housing half 12 and an upper housing half 14 (FIGS. 4 and 5). The lower housing half 12 has a flat top 16, a central opening 18, a circular peripheral edge 20, and a female threaded region 22 on its bottom. The region 22 is threaded to mate with the male threads on the top 4 of the bottle 6.

The upper housing half 14 has a flat bottom 24, a central opening 26, a male threaded region 10, and a circular peripheral edge 28.

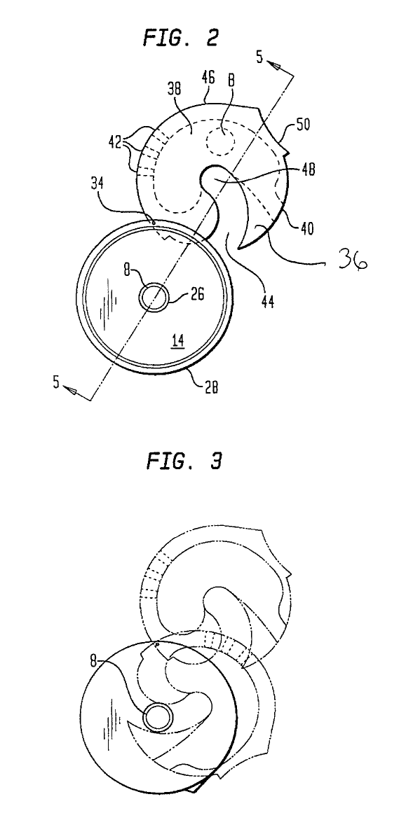

The housing halves 12 and 14 are maintained in proper relationship (wherein their peripheral edges 20 and 28 are aligned) by a connecting post 34 (FIG. 2) that is secured to each of the housing halves 12 and 14 adjacent their peripheral edges 20 and 28 respectively, and by a tube 8 connecting their central openings 18 and 26. The tube 8 allows liquid in the bottle 6 to flow out when the bottle 6 is inverted or when a straw (not shown) is inserted into the bottle through the tube 8.

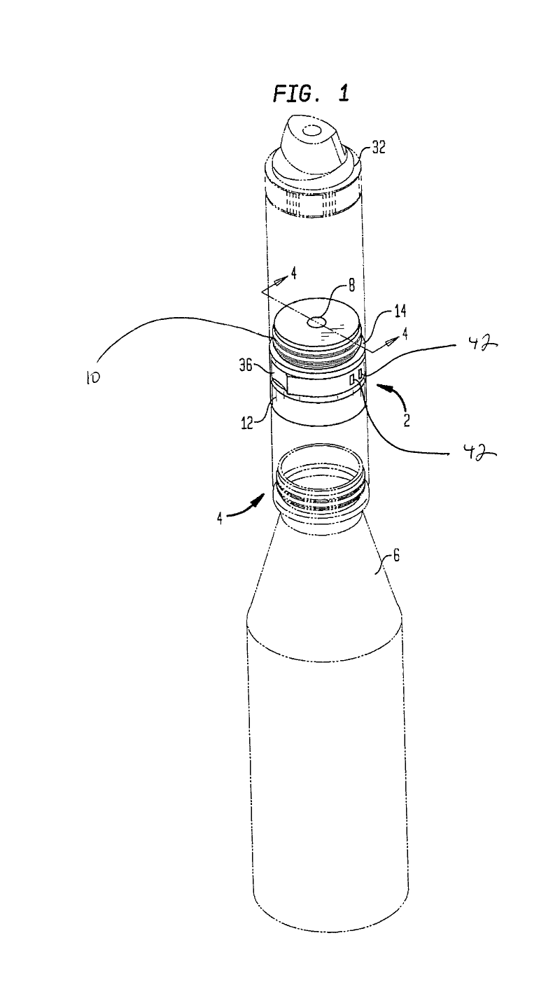

In the preferred embodiment, the post 34 serves as a hinge for the whistle body generally indicated by reference numeral 36. (This may expediently be accomplished by providing an opening in the whistle body 36, aligning this opening with openings in the upper and lower housing halves 10 and 12, and press-fitting the post 34 through the aligned holes. This is not required, and the hinge can be made otherwise.) This permits the whistle body 36 to be pivoted out to an open position (FIG. 2) for use, and to be pivoted back to a closed position (FIG. 1) afterwards.

The whistle body 36 is generally disc-shaped, and contains a hollow cavity 38 that is open to the outside at its narrowed entrance 40 and its narrow whistle holes 42. When a user blows into the entrance 40 of the cavity 38, the airstream (not shown) is forced out the whistle holes 42 to make noise. (The number and shape of the whistle holes 42 are chosen to make the noise desired, which may be a dissonance, a chord, or any sound desired.)

Optionally, a ball B of e.g. pith may be introduced within the cavity 38 through the entrance 40 and is blown therein the airstream to intermittently block one or more of the whistle holes 42. This may be done by soaking the ball B in water, introducing the ball B into the cavity 38 in a wet state, and allowing the ball B to dry out and thereby expand so that it cannot fall out of the entrance 40.

The whistle body 36 cannot cut or close the tube 8, because a user must be able to drink from the bottle 6 whether the whistle body 36 is in the open or the closed position. To this end, a curved slot 44 (FIGS. 2 and 3) extends entirely through the whistle body 36. The slot 44 extends between the peripheral edge 46 of the whistle body 36 and the center 48 thereof, and is shaped such that regardless of the position of the whistle body 36, the tube 8 will always be located in a portion of the slot 44. In this way, the whistle body 36 can be opened and closed without interfering with the tube 8 (FIG. 3).

To make it easier to open and close the whistle body 36, a region 50 of the peripheral edge 46 has a reversed curvature and is slightly extended, so that it projects beyond the edges 20 and 28 when the whistle body 36 is in the closed position.

Advantageously, and for economy, all the components (the tube 8 and all the parts of the whistle 2) are made of plastic. The whistle body may be an injection-molded part. And, although the preferred embodiment is designed to be threaded upon the top 4 of a bottle 6, this is not required. It is alternatively possible to design the whistle 2 so that it seals over an unthreaded bottle top with a seal 52 of e.g. a flexible polymer (FIG. 5).

As shown in FIG. 1, the cap 32 (in this instance, a closable cap) that comes threaded upon the top 4 of the bottle 6 may optionally be threaded onto the male threaded region 12 prevent spillage when a user is not drinking the contents of the bottle 6. However, this is not a part of the invention, and is not required.

Although at least one preferred embodiment of the invention has been described above, this description is not limiting and is only exemplary. The scope of the invention is defined only by the claims, which follow:

1. A whistle, comprising:
a lower housing half having a flat top, a bottom having a means for sealing engagement over a bottle top, a central opening, and a peripheral edge;
an upper housing half having a flat bottom, a central opening, and a peripheral edge;
a hollow open-ended tube connecting the central openings of the top and bottom housing halves; and
a whistle body with a peripheral edge and a center, the whistle body being pivotally secured between the housing halves and being rotatable between them along a path that begins at an open position and ends at a closed position wherein the peripheral edge of the whistle body is generally aligned with the peripheral edges of the housing halves, the whistle body having a curved slot extending between its edge and its center, and the slot being shaped in a manner that motion of the whistle body remains unobstructed by the tube at all points along said path.

2. The whistle of claim 1, wherein the means for sealing engagement is a female threaded region dimensioned to be threaded onto a threaded bottle top.

3. The whistle of claim 1, wherein the means for sealing engagement is a polymer.

4. The whistle of claim 1, wherein the housing halves, connecting post, whistle body, and tube are all of plastic.

5. The whistle of claim 1, further comprising a post attached to the housing halves adjacent their peripheral edges, and wherein the whistle body is pivotally secured to the post.

6. The whistle of claim 5, wherein the post passes through the whistle body.

7. The whistle of claim 1, wherein all the peripheral edges are circular.

8. The whistle of claim 1, further comprising a male threaded region located on the upper housing half.

9. The whistle of claim 8, wherein the male threaded region is dimensioned to be threaded into a threaded bottle cap.

10. A whistle, comprising:
a lower housing half having a flat top, a bottom having a female threaded region and a central opening, and a circular peripheral edge;
an upper housing half having a flat bottom, a central opening, and a circular peripheral edge;
a hollow open-ended tube connecting the central openings of the top and bottom housing halves; and
a whistle body with a circular peripheral edge and a center, the whistle body being pivotally secured between the housing halves and being rotatable along a path that begins at an open position and ends at a closed position wherein the peripheral edge of the whistle body is generally aligned with the peripheral edges of the housing halves, the whistle body having a curved slot extending between its edge and its center, and the slot being shaped in a manner that motion of the whistle body is unobstructed by the tube at all points along said path.

11. The whistle of claim 10, further comprising a connecting post attached to the housing halves adjacent their peripheral edges, the whistle body being rotatable upon the connecting post.

12. The whistle of claim 10, wherein the female threaded region is dimensioned to correspond to a threaded cap for the bottle top.

13. The whistle of claim 10, further comprising a male threaded region located on the upper housing half.

14. The whistle of claim 13, wherein the male threaded region is dimensioned to be threaded into a threaded bottle cap.

15. A whistle adapted to be sealed to the top of a bottle, comprising:
a lower housing half having a flat top, a bottom having a means for sealing engagement over a bottle top, a central opening, and a circular peripheral edge;
an upper housing half having a flat bottom, a central opening, and a circular peripheral edge;
a hollow open-ended tube connecting the central openings of the top and bottom housing halves; and
a whistle body with a circular peripheral edge and a center, the whistle body being pivotally secured between the housing halves and rotatable between them along a path that begins at an open position and ends at a closed position wherein the peripheral edge of the whistle body is generally aligned with the peripheral edges of the housing halves, the whistle body having a curved slot extending between its edge and its center, and the slot being shaped in a manner that motion of the whistle body is unobstructed by the tube at all points along said path.

16. An all-plastic whistle, comprising:
a lower housing half having a flat top, a bottom having a female threaded region, a central opening, and a circular peripheral edge;
an upper housing half having a flat bottom, a top having a male threaded region, a central opening, and a circular peripheral edge;
a hollow open-ended tube connecting the central openings of the top and bottom housing halves;
a connecting post connecting the top and bottom housing halves so that their peripheral edges and central openings are aligned; and
a whistle body with a circular peripheral edge and a center, the whistle body being pivotally secured to the connecting post and rotatable between the housing halves along a path that begins at an open position and ends at a closed position wherein the peripheral edge of the whistle body is generally aligned with the peripheral edges of the housing halves, the whistle body having a curved slot extending between its edge and its center, and the slot being shaped in a manner that motion of the whistle body is unobstructed by the tube at all points along said path.

17. An all-plastic whistle adapted to be threaded onto a bottle top, comprising:
a lower housing half having a flat top, a bottom having a female threaded region dimensioned to be threaded onto a threaded bottle top, a central opening, and a circular peripheral edge;
an upper housing half having a flat bottom, a male threaded region, a central opening, and a circular peripheral edge;
a hollow open-ended tube connecting the central openings of the top and bottom housing halves; and
a connecting post connecting the top and bottom housing halves so that their peripheral edges and central openings are aligned;
an injection-molded whistle body with a circular peripheral edge and a center, the whistle body being pivotally secured to the connecting post and rotatable between the housing halves along a path that begins at an open position and ends at a closed position wherein the peripheral edge of the whistle body is generally aligned with the peripheral edges of the housing halves, the whistle body having a curved slot extending between its edge and its center, and the slot being shaped in a manner that motion of the whistle body is unobstructed by the tube at all points along said path.

18. An all-plastic whistle adapted to be sealed to a bottle top, comprising:
a lower housing half having a flat top, a bottom having a means for sealingly attaching the whistle over a bottle top, a central opening, and a circular peripheral edge;
an upper housing half having a flat bottom, a central opening, and a circular peripheral edge;
a hollow open-ended tube connecting the central openings of the top and bottom housing halves; and
a connecting post connecting the top and bottom housing halves so that their peripheral edges and central openings are aligned; and
a whistle body with a circular peripheral edge and a center, the whistle body being pivotally secured to the connecting post and rotatable between the housing halves along a path that begins at an open position and ends at a closed position wherein the peripheral edge of the whistle body is generally aligned with the peripheral edges of the housing halves, the whistle body having a curved slot extending between its edge and its center, and the slot being shaped in a manner that motion of the whistle body is unobstructed by the tube at all points along said path.

19. A whistle adapted for sealing engagement over a bottle top, the whistle having a central passageway through which liquid may flow out of the bottle.
